(19) United States
(12) Patent Application Publication
(10) Pub. No.: US 2014/0201630 A1
(43) Pub. Date: Jul. 17, 2014

(54) Sound Decomposition Techniques and User Interfaces

(71) Applicant: ADOBE SYSTEMS INCORPORATED, San Jose, CA (US)

(72) Inventors: Nicholas J. Bryan, San Francisco, CA (US); Gautham J. Mysore, San Francisco, CA (US)

(73) Assignee: ADOBE SYSTEMS INCORPORATED, San Jose, CA (US)

(21) Appl. No.: 13/743,150

(22) Filed: Jan. 16, 2013

(51) Int. Cl. H04R 29/00

(52) U.S. Cl. CPC H04R 29/008
USPC 715/716

(57) ABSTRACT

Sound decomposition techniques and user interfaces are described. In one or more implementations, one or more inputs are received via interaction with a representation of sound data in a user interface, the one or more inputs indicating a portion and corresponding intensity of the sound data. The sound data is decomposed according to at least one respective source based at least in part on the selected portion and indicated intensity to guide a learning process used in the decomposing. Other implementations are also contemplated, such as implementations that do not involve an indication of intensity, implementations involving concurrent display of sound data as being associated with respective sources, and so on.

### BACKGROUND

Sound decomposition may be leveraged to support a wide range of functionality. For example, sound data may be captured for use as part of a movie, recording of a song, and so on. Parts of the sound data, however, may be noisy or may include different parts that are and are not desirable. The sound data, for instance, may include dialog for a movie which is desirable, but may also include sound data of an unintended ringing of a cell phone. Accordingly, the sound data may be decomposed according to different sources such that the sound data corresponding to the dialog may be separated from the sound data that corresponds to the cell phone.

However, conventional techniques that are employed to automatically perform this decomposition could result in inaccuracies as well as be resource intensive and thus ill-suited for use as part of an interactive system. For example, conventional techniques typically employed a “one and done” process in which processing was performed automatically often using a significant amount of time to produce a result that may or may not be accurate. Consequently, such a process could result in user frustration and limit usefulness of these conventional techniques.

### SUMMARY

A sound decomposition user interface and algorithmic techniques are described. In one or more implementations, one or more inputs are received via interaction with a representation of sound data in a user interface, the one or more inputs indicating a portion and corresponding intensity of the sound data. The sound data is decomposed according to at least one respective source based at least in part on the selected portion and indicated intensity to guide a learning process used in the decomposing. Other implementations are also contemplated, such as implementations that do not involve an indication of intensity, implementations involving concurrent display of sound data as being associated with respective sources, and so on.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ sound decomposition techniques as described herein.

FIG. 2 depicts a system in an example implementation in which source separated sound data is generated from sound data from FIG. 1 through use of a decomposition module.

FIG. 3 depicts a system in an example implementation in which an example decomposition user interface is shown that includes a representation of sound data from a recording.

FIG. 4 depicts an example implementation in which user interaction with a user interface is utilized to generate an indication of likely correspondence of sound data to a source.

FIG. 5 depicts an example implementation in which a result of a decomposition performed as part of FIG. 4 is iteratively refined.

FIG. 6 depicts an example implementation in which user interaction with a user interface is utilized to generate an indication of likely correspondence of sound data to a plurality of different sources.

FIG. 7 depicts an example of an expectation maximization algorithm employable for probabilistic latent component analysis.

FIG. 8 depicts another example of an expectation maximization algorithm employable for probabilistic latent component analysis.

FIG. 9 depicts an example in which indications configured as user annotations are employed as a mask.

FIG. 10 depicts an additional example of an expectation maximization algorithm employable for probabilistic latent component analysis.

FIG. 11 depicts a further example of an expectation maximization algorithm employable for probabilistic latent component analysis that incorporates the indications, e.g., user annotations.

FIG. 12 is a flow diagram depicting a procedure in an example implementation in which a user interface supports user interaction to guide decomposing of sound data.

FIG. 13 is a flow diagram depicting a procedure in an example implementation in which a user interface supports simultaneous display of representations of audio data decomposed according to a plurality of different sources.

FIG. 14 illustrates an example system including various components of an example device that can be implemented as any type of computing device as described and/or utilize with reference to FIGS. 1-13 to implement embodiments of the techniques described herein.

### DETAILED DESCRIPTION

Overview

Conventional sound decomposition techniques could take a significant amount of time and could be “hit or miss,” especially in instances in which training data is not available. Accordingly, these conventional techniques could provide limited usefulness.

Sound decomposition user interface techniques are described. In one or more implementations, a user interface is output that includes representations of sound data, such as a time/frequency representation. Tools are supported by the user interface in which a user may identify different parts of the representation as corresponding to a respective source. For example, a user may interact with the user interface to “brush over” portions of the representation involving dialog, may identify other portions as involving a car siren, and so on.

The inputs provided via this interaction may then be used to guide a process to decompose the sound data according to the respective sources. For example, the inputs may be used to interactively constrain a latent variable model to impose linear grouping constraints. Thus, these techniques may be utilized even in instances in which training data is not available and simultaneously be very efficient, thereby even support use in interactive system with user feedback to improve results. Further discussion of these and other techniques may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

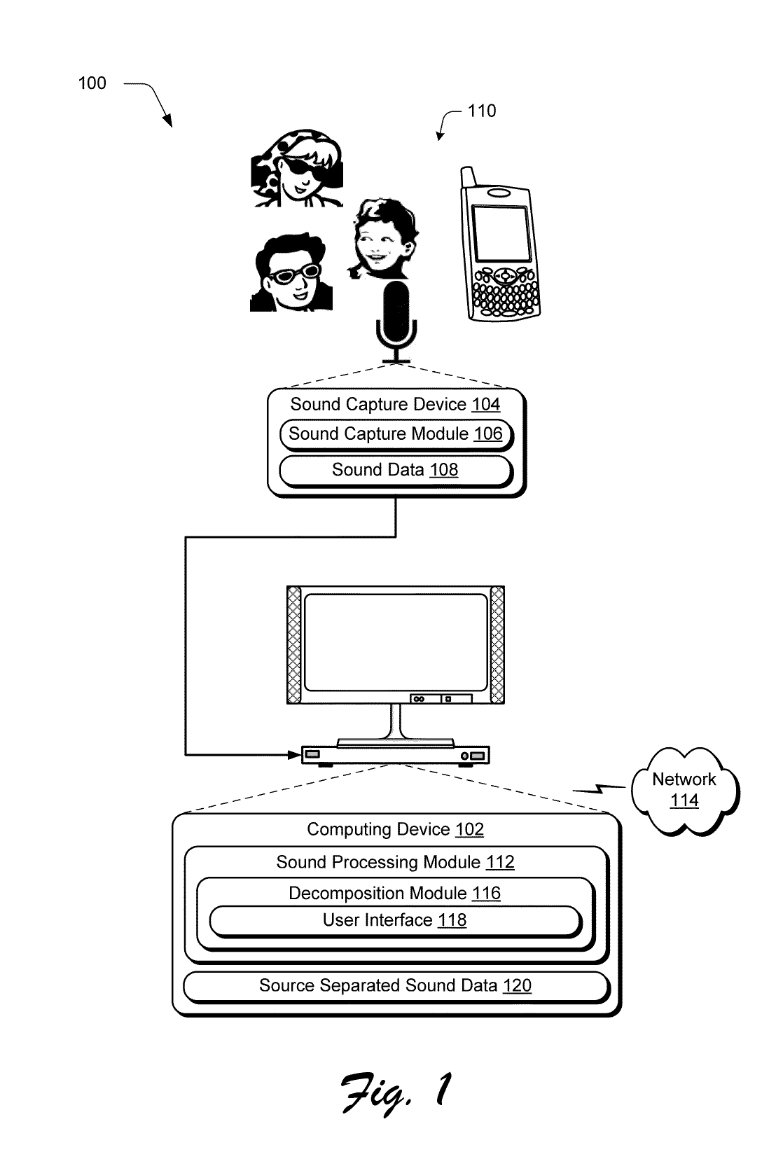

FIG. 1 is an illustration of an environment 100 in an example implementation that is operable to employ sound decomposition techniques described herein. The illustrated environment 100 includes a computing device 102 and sound capture device 104, which may be configured in a variety of ways.

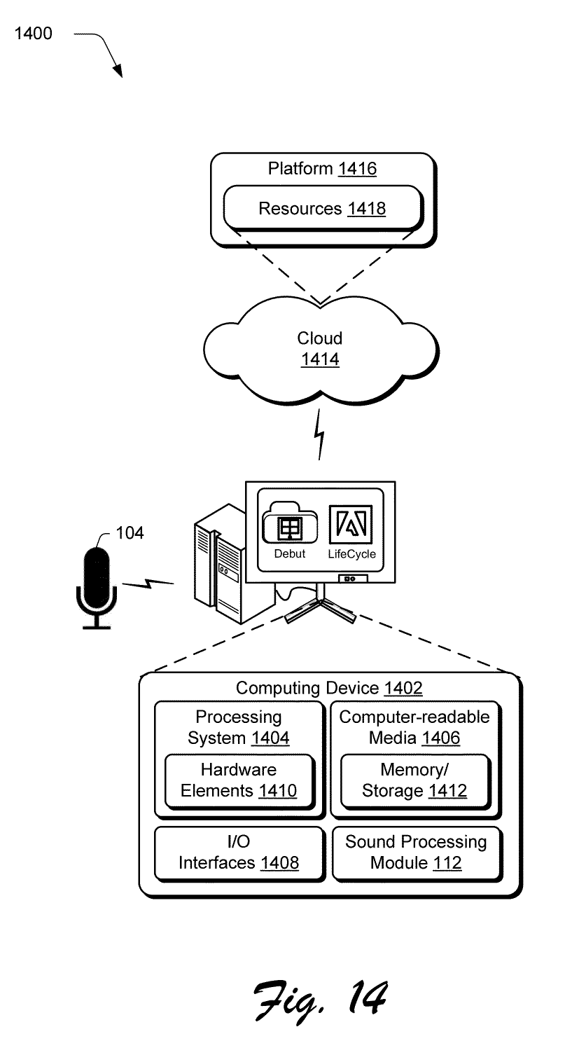

The computing device 102, for instance, may be configured as a desktop computer, a laptop computer, a mobile device (e.g., assuming a handheld configuration such as a tablet or mobile phone), and so forth. Thus, the computing device 102 may range from full resource devices with substantial memory and processor resources (e.g., personal computers, game consoles) to a low-resource device with limited memory and/or processing resources (e.g., mobile devices). Additionally, although a single computing device 102 is shown, the computing device 102 may be representative of a plurality of different devices, such as multiple servers utilized by a business to perform operations “over the cloud” as further described in relation to FIG. 14.

The sound capture device 104 may also be configured in a variety of ways. Illustrated examples of one such configuration involves a standalone device but other configurations are also contemplated, such as part of a mobile phone, video camera, tablet computer, part of a desktop microphone, array microphone, and so on. Additionally, although the sound capture device 104 is illustrated separately from the computing device 102, the sound capture device 104 may be configured as part of the computing device 102, the sound capture device 104 may be representative of a plurality of sound capture devices, and so on.

The sound capture device 104 is illustrated as including respective sound capture module 106 that is representative of functionality to generate sound data 108. The sound capture device 104, for instance, may generate the sound data 108 as a recording of an audio scene 110 having one or more sources. This sound data 108 may then be obtained by the computing device 102 for processing.

The computing device 102 is illustrated as including a sound processing module 112. The sound processing module is representative of functionality to process the sound data 108. Although illustrated as part of the computing device 102, functionality represented by the sound processing module 112 may be further divided, such as to be performed “over the cloud” via a network 114 connection, further discussion of which may be found in relation to FIG. 14.

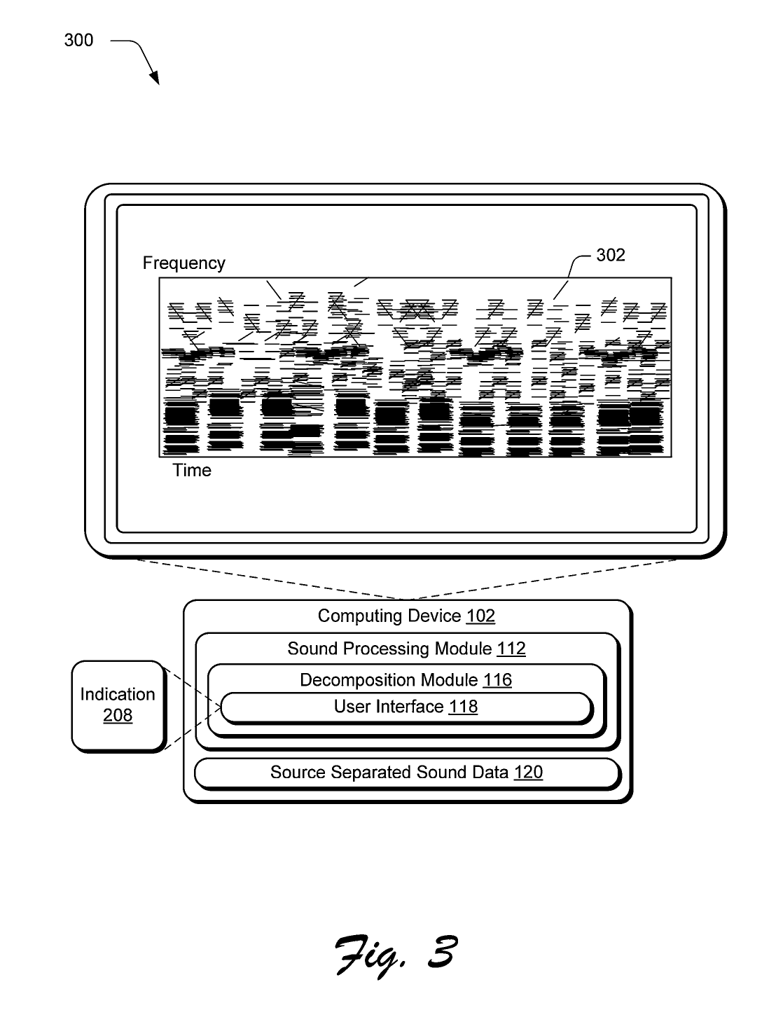

An example of functionality of the sound processing module 112 is represented as a decomposition module 116. The decomposition module 116 is representative of functionality to decompose the sound data 108 according to a likely source of the data. As illustrated in the audio scene 110 of FIG. 1, for instance, the decomposition module 116 may expose a user interface 118 having representations of the sound data 108. A user may then interact with the user interface 118 to provide inputs that may be leveraged by the decomposition module 116 to decompose the sound data 108. This may include separation of the sound data 108 according to different sources, such as to separate dialog from the people in the audio scene 110 from ringing of a cell phone to form the source separated sound data 120. This may be used to support a variety of different functionality, such as audio denoising, music transcription, music remixing, audio-based forensics, and so on. The user interface 118 may be configured in a variety of ways, an example of which is shown and described in relation to FIG. 3.

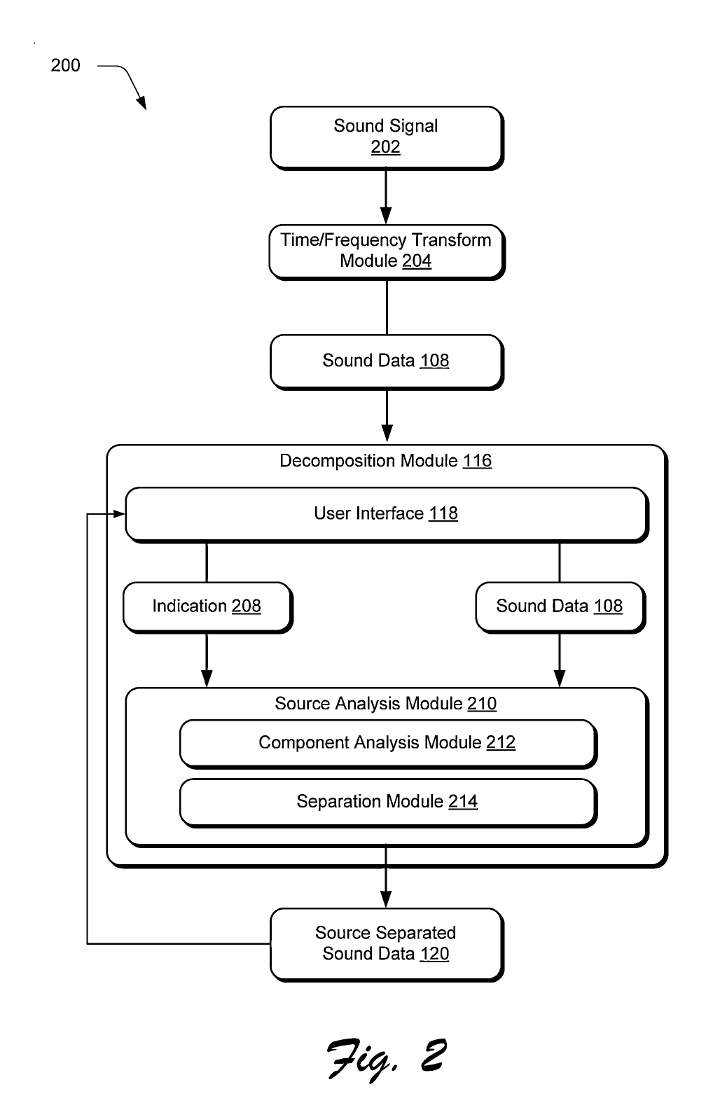

FIG. 2 depicts a system 200 in an example implementation in which source separated sound data 120 is generated from sound data 108 from FIG. 1 through use of a decomposition module 116. A sound signal 202 is processed by a time/frequency transform module 204 to create sound data 108, which may be configured in a variety of ways.

The sound data, for instance, may be used to form one or more spectrograms of a respective signal. For example, a time-domain signal may be received and processed to produce a time-frequency representation, e.g., a spectrogram, which may be output in a user interface 118 for viewing by a user. Other representations are also contemplated, such as different time-frequency representations, a time domain representation, an original time domain signal, and so on.

Spectrograms may be generated in a variety of ways, an example of which includes calculation as magnitudes of short time Fourier transforms (STFT) of the signals. Additionally, the spectrograms may assume a variety of configurations. The STFT sub-bands may be combined in a way so as to approximate logarithmically-spaced or other nonlinearly-spaced sub-bands.

The sound data 108 is illustrated as being received for output by a user interface 118 of the decomposition module 116. The user interface 118 is configured to output representations of sound data, such as a time or time/frequency representation of the sound data 108 as previously described. In this way, a user may view characteristics of the sound data and identify different portions that may be indicative of a respective source. A user may then interact with the user interface 118 to define portions of the sound data 108 that correspond to a particular source.

This interaction may then be provided as an indication 208 along with the sound data 108 to a source analysis module 210. The source analysis module 210 is representative of functionality to identify sources of parts of the sound data 108. The source analysis module 210, for instance, may include a component analysis module 212 that is representative of functionality to identify components in the sound data 108 and that may leverage the indication 208 are part of this identification. For example, the component analysis module 212 may leverage a latent variable model (e.g., probabilistic latent component analysis) to estimate a likely contribution of each source to portions of the sound data 108. The indication 208 may be used to constrain the latent variable model to weakly label features to guide a learning process performed by the component analysis module 212. Thus, the indication 208 may be used to impose linear grouping constraints that are employed by the component analysis module 212, which may be used to support interactive techniques as further described below.

A separation module 214 may then be employed to separate the sound data 108 based on labeling resulting from the analysis of the component analysis module 212 to generate the source separated sound data 120. Further, these techniques may also be used to support an iterative process, such as to display the source separated sound data 120 in the user interface 118 to generate additional indications 208 as illustrated by the arrow in the system 200. An example user interface is discussed as follows in relation to a corresponding figure.

FIG. 3 depicts an example implementation 300 showing the computing device 102 of FIG. 1 as outputting a user interface 118 output for display. In this example, the computing device 102 is illustrated as assuming a mobile form factor (e.g., a tablet computer) although other implementations are also contemplated as previously described. In the illustrated example, a representation 302 of the sound data 108 recorded from the audio scene 110 of FIG. 1 is displayed in the user interface 118 using a time-frequency representation, e.g., spectrograms, although other examples are also contemplated.

In applications such as audio denoising, music transcription, music remixing, and audio-based forensics, it is desirable to decompose a single channel recording into its respective sources. Conventional techniques, however, typically perform poorly when training data is not available, e.g., training data isolated by source.

To overcome this issue, a user may interact with the user interface 118 to provide indications 208 to guide calculations performed by the decomposition module 116. These indications 208 may be provided via a variety of different inputs, an example of which is described as follows and shown in a corresponding figure.

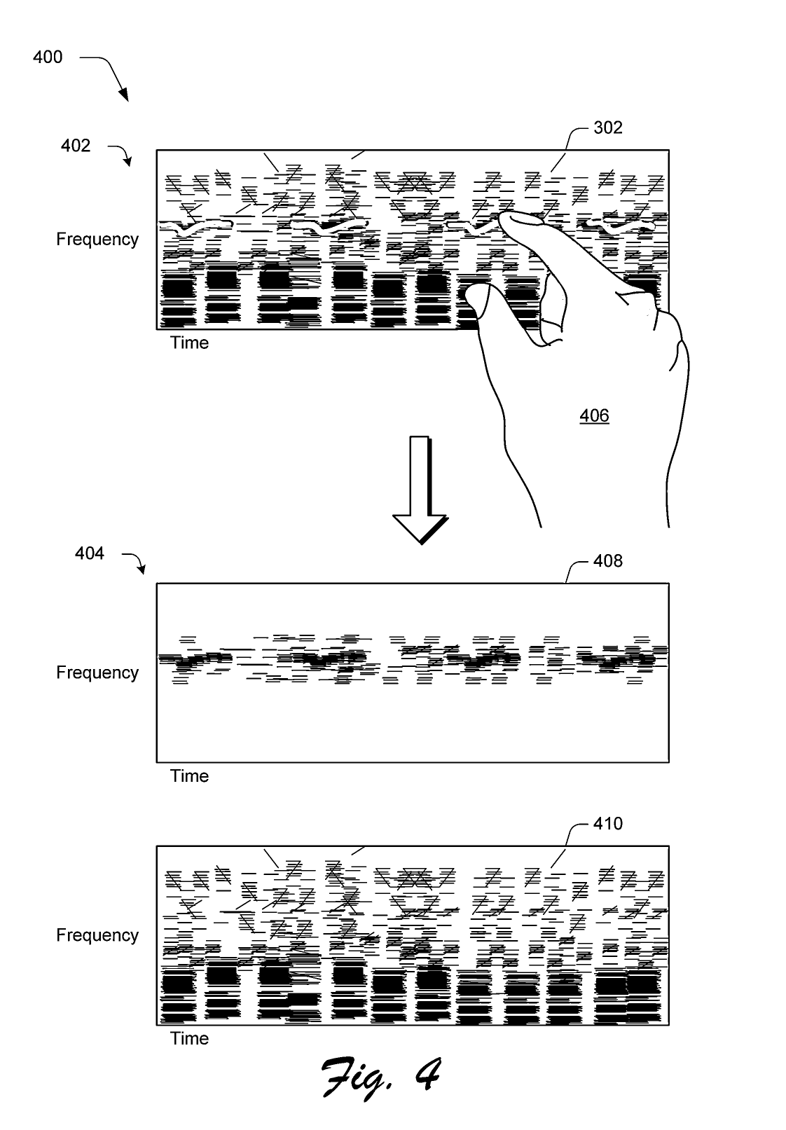

FIG. 4 depicts an example implementation 400 in which user interaction with a user interface is utilized to generate an indication of likely correspondence of sound data to a source. This implementation 400 is shown through the use of first and second stages 402, 404, which although illustrated as stages these portions may be displayed concurrently in a user interface, e.g., to add the second stage 404 to a display of the first stage 402.

Continuing with the previous example, the representation 302 may provide a time/frequency representation of sound data 108 captured from the audio scene 110 of FIG. 1. According, the sound data 108 may include portions that include dialog as well as portions that include a ringing of a cell phone.

To separate the sound data as corresponding to the respective sources (e.g., dialog from people and ringing cell phone) a user may interact with the user interface 302 to weakly label (e.g., annotate) portions of the representation as corresponding to a cell phone in this example. This is illustrated through detection of gestures input via a hand 406 of a user to “paint” or “brush over” portions of the representation that likely correspond to the ringing in the cell phone, which is illustrated as gray brush strokes over four repeated rings in the illustrated representation 302.

These inputs may thus serve as indications 208 of weak labels to corresponding portions of the sound data 108. The source analysis module 210 of the decomposition module 116 may then use these indications 208 to generate the source separated sound data 120. For example, the indications 208 may be used to weakly label instead of strictly label the portions of the sound data 108.

Therefore, instead performing a strict extraction of the indicated portions using the strict labels as in conventional techniques, the weak labels may be used to guide the source analysis module 210. In this way, the component analysis module 212 may address a likely mix of sound data from different sources at the portions such that the sound data at those portions may be separated to a plurality of different sources, as opposed to strict conventional techniques in which the sound data from the portion was separated to a single source.

As illustrated as the second stage 404, for instance, source separated sound data 120 generated by the decomposition module 116 is illustrated using first and second representations 408, 410 that are displayed concurrently in a user interface. The first and second representations 408, 410 each correspond to a likely source identified through processing by the module, such as a ring of a cell phone for the first representation 408 as separated from other sources, such as dialog of the users as well as background noise of the audio scene 110 for the second representation. Thus, as illustrated both the first and second representations 408, 410 include sound data from the portions indicated at the first stage 402 and those indications may be used to weakly label a likely source of the portion of the sound data. These techniques may also be iterative such that a user may iteratively “correct” the output to achieve a desired decomposition of the sound data 108, an example of which is described as following and shown in a corresponding figure.

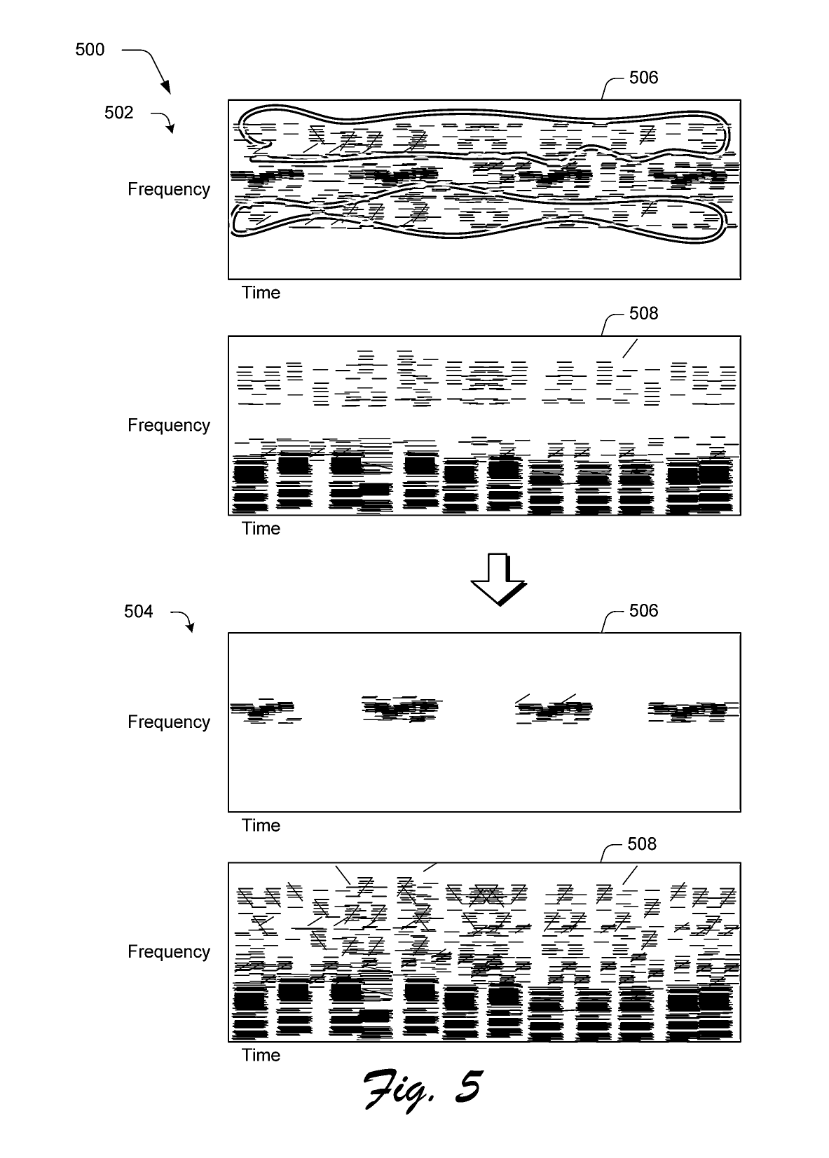

FIG. 5 depicts an example implementation 500 in which a result of a decomposition performed as part of FIG. 4 is iteratively refined. This example implementation is also shown using first and second stages 502, 504. At the first stage 502, another example of a result of decomposition performed by the decomposition module 116 based on the indication is shown. As before, first and second representations 506, 508 are displayed as likely corresponding to respective sources, such as a cell phone and dialog as previously described.

However, in this example a result of the processing performed by the decomposition module 116 is less accurate such that parts of the sound data that likely corresponds to the dialog is included in the cell phone separated sound data. Accordingly, indications 208 are generated through interaction with the user interface that indicate portions included in the first representation 506 that are to be included in the second representation 508.

In the illustrated example, the interaction is provided by specifying boundaries of the portions such that sound data located within those boundaries likely corresponds to a respective source. Thus, rather than “brushing over” each region, boundaries are selected for the region. A variety of other examples are also contemplated, such as through use of a cursor control device (e.g., to draw a boundary, brush over), voice command, and so on. Further, although “what is wrong” is described in this example to remove sound data from one representation to another, other examples are also contemplated, such as to indicate “what is correct” such that other sound data not so indicated through user interaction is removed.

At the second stage 504, a result of processing performed by the decomposition module 116 is illustrated in which the first and second representations 506, 508 are again displayed. In this example, however, the first and second representations 506, 508 are updated with a result of the processing performed based on interaction performed at the first stage 402 of FIG. 4 as well as interaction performed at the first stage 502 of FIG. 5. Thus, as illustrated the decomposition module 116 and user interface 118 may support iterative techniques as previously described in relation to FIG. 2 in which a user may successively refine source separation through successive output of processing performed by the module. Although identification of correspondence of portions of sound data to a single source was described, it should be readily apparent that multiple interactions may be performed to indicate likely correspondence to a plurality of different sources, an example of which is described as follows and shown in a corresponding figure.

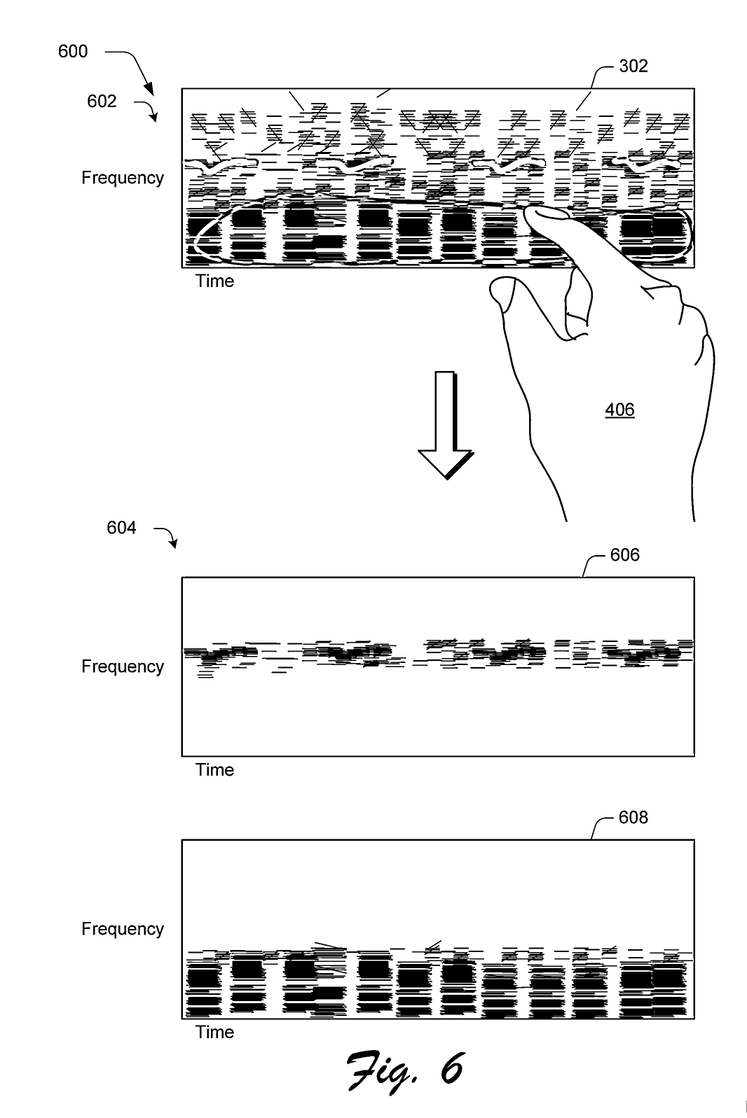

FIG. 6 depicts an example implementation 600 in which user interaction with a user interface is utilized to generate an indication of likely correspondence of sound data to a plurality of different sources. This implementation is illustrated using first and second stages 602, 604. The first stage 602 is output for display initially in a user interface 118 that includes a representation 302 of the sound data 108 captured for the audio scene 110 of FIG. 1.

A user may then interact with a variety of different tools to identify portions of the represented 302 sound data 108 as corresponding to particular audio sources. For example, brush tools, boundary tools, and so on may be used to apply different display characteristics that correspond to different audio sources. A brush tool, for instance, may be used to paint portions of the representation 302 that likely correspond to a ringing of a cell phone in red. A user may then select a boundary tool in blue as specify portions of the representation 302 that likely correspond to dialog in blue. Other display characteristics are also contemplated without departing from the spirit and scope thereof.

The decomposition module 116 may then decompose the sound data as previously described and output a result of this processing in first and second representations 606, 608 in the user interface as shown in the second stage 604 along with the representation 302 of the sound data 108. Continuing with the above example, the first representation 606 may display the sound data that likely corresponds to the ringing of the cell phone in red. The second representation 608 may describe the sound data that likely corresponds to the dialog in blue. As previously described, iteration may also be supported in which a user may interact with any of the representations 302, 606, 608 to further refine the decomposition performed by the module. Although two sources were described, it should be readily apparent that these techniques may be applied for any number of sources to indicate likely correspondence of portions of the sound data 108.

Additionally, a variety of different techniques may be employed by the decomposition module 116 to generate the source separated sound data 120. For example, non-negative matrix factorization (NMF) and its probabilistic latent variable model counterparts may be used to process sound data 108 that is configured according to an audio spectrogram. Given that audio spectrogram data is the magnitude of the short-time Fourier transform (STFT), these methods decompose the nonnegative data as non-negative basis or dictionary elements that collectively form a parts-based representation of sound. By associating a single dictionary to each of a collection of sounds, an unknown mixture can be modeled as a linear weighted combination of each dictionary over time. The activations or weights are then used to estimate the contribution of each sound source within the mixture and then to reconstruct each source independently knowing the original mixture spectrogram and STFT phase.

These techniques may achieve good separation results and high quality renderings of the individual sound sources conventionally when leveraging isolated training data of each source within a mixture. In many cases, however, the techniques are plagued with a lack of separation, sound artifacts, musical noise, and other undesirable effects that limit the general usefulness of the technique, especially when isolated training data is not available.

Accordingly, the techniques described herein may overcome these issues by providing a user interface via which a user may weakly label time-frequency features as corresponding to a particular source, such as through brush strokes, boundary boxes, and so on as described above. The indications (e.g., annotations) may then be incorporated as linear grouping constraints into a probabilistic latent variable model by way of posterior regularization.

The use of posterior regularization allows for efficient time-frequency constraints that would be increasingly difficult to achieve using Bayesian prior-based regularization, with minimal additional computational complexity. More specifically, given a simple linear grouping constraint on the posterior, an expectation maximization algorithm with closed-form multiplicative updates is derived, drawing close connection to non-negative matrix factorization methods, and allowing for interactive-rate separation without use of prior training data.

In one example, these techniques may employ a probabilistic model to perform the decomposition, e.g., sound source separation, although other examples are also contemplated, such as nonnegative matric factorization and related latent variable models. For example, these techniques may build off of a symmetric (or asymmetric) probabilistic latent component analysis (PLCA) model, which is an extension of probabilistic latent semantic indexing (PLSI) and probabilistic latent semantic analysis (PLSA). The general PLCA model is defined as a factorized probabilistic latent variable model of the following form:

$$p ( x ) = {\sum }_{z} p ( z ) {\prod }_{j = 1}^{N} p ( {x}_{j} \vert z )$$

where “p(x)” is an N-dimensional distribution of a random variable “x=x₁, x₂, . . . , xₙ,” “p(z)” is the distribution of the latent variable “z,” “p(xⱼ|z)” are the one dimensional distributions, and the parameters of the distributions “Θ” are implicit in the notation.

When employed to perform sound separation, a two dimensional variant of the PLCA model may be used to approximate a normalized audio spectrogram “X,” using slightly modified notation (f≡x₁ and t≡x₂) to arrive at the following:

$$p ( f , t ) = {\sum }_{z} p ( z ) p ( f \vert z ) p ( t \vert z )$$

The random variables “f,” “t,” and “z” are discrete and can take on “N_{f},” “Nₜ,” and “N_{z}” possible values respectively. The conditional distribution “p(f|z)” is a multinomial distribution representing frequency basis vectors or dictionary elements for each source, and “p(t|z)” is a multinomial distribution representing the weighting or activations of each frequency basis vector. “N_{z}” is typically chosen by a user and “N_{f}” and “Nₜ” are a function of the overall length of the sound and STFT parameters (Fourier transform length and hop size). In the context of PLSI and text-based information retrieval, each time outcome corresponds to an individual document and each frequency corresponds to a distinct word.

To model multiple sound sources “Nₛ” within a mixture, non-overlapping values of the latent variable are associated with each source. Once estimated, the distinct groupings are the used to reconstruct each source independently.

The described interactive, weakly supervised techniques described above may be used to help a user guide the factorization. Before the technique is discussed, however, a description follows detailing how the model is fit to an observed spectrogram using an expectation-maximization algorithm and posterior regularization is discussed.

Given the above model and observed data “X,” an expectation-maximization (EM) algorithm may be used to find a maximum likelihood solution. The may include following an approach of lower bounding the log-likelihood as follows:

$$ln p ( X \vert Θ ) = ℱ ( q , Θ ) + KL ( q \vert \vert p )$$

$$ℱ ( q , Θ ) = {\sum }_{Z} q ( Z ) ln \{ \frac{p ( X , Z \vert Θ )}{q ( Z )} \}$$

$$\begin{matrix}KL ( q \vert \vert p ) = KL ( q ( Z ) \vert \vert p ( z \vert X , Θ ) ) \\ = - {\sum }_{Z} q ( Z ) ln \{ \frac{p ( Z \vert X , Θ )}{q ( Z )} \}\end{matrix}$$

for any discrete distribution “q(Z),” denoted by “q” for compactness, where “KL(q∥p)” is the Kullback-Leibler divergence and “ [symbol] (q,Θ)” is the lower bound as a result of “KL(q∥p)” being non-negative.

With an initial guess of the model parameters, a two-stage coordinate ascent optimization may be solved that maximized the lower bound “ [symbol] (q,Θ)” or equivalently minimizes “KL(q∥p)” with respect to “q:”

$$\begin{matrix}{q}^{( n )} = {argmax}_{q} ℱ ( q , {Θ}^{( n )} ) \\ = {argmin}_{q} KL ( q \vert \vert p )\end{matrix}$$

and then maximizes the lower bound with respect to “Θ” as follows:

$${Θ}^{( n )} = {argmax}_{Θ} ℱ ( {q}^{( n )} , Θ )$$

This process as used may guarantee parameter estimates “Θ” to monotonically increase the lower bound “ [symbol] (q,Θ)” until convergence to a local stationary point. Also note that the expectation step typically involves computing the posterior distribution “p(Z|X,Θ)” solely as “q(Z)” is optimal when equal to the posterior, making it common to implicitly define “q(Z),” solely. In discussion of the concept of posterior regularization below, however, an explicit representation of “q(Z)” is used.

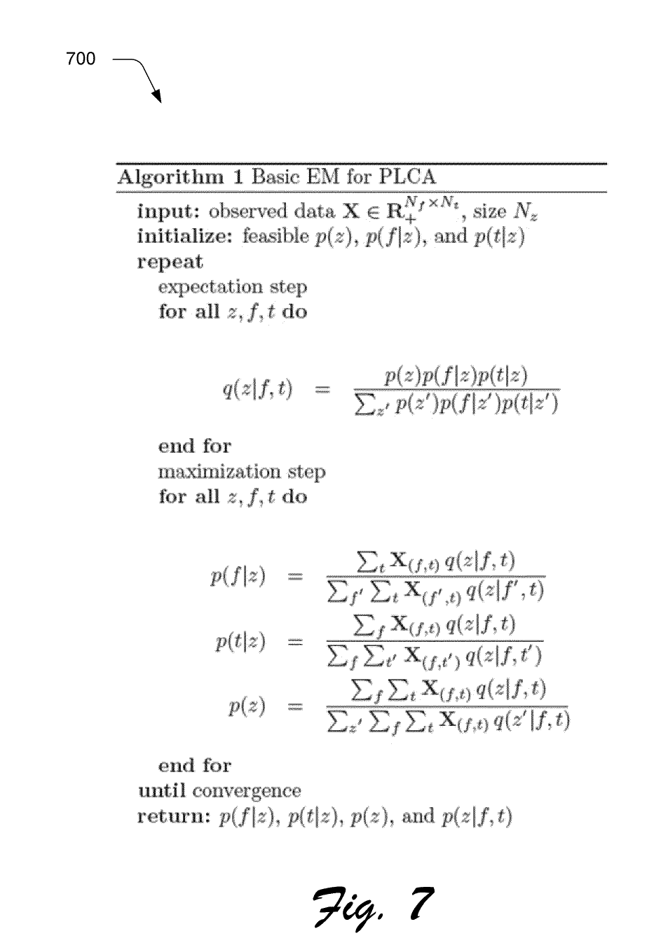

Applying the above techniques to solve for the maximum likelihood parameters of the sound model, a simple iterative EM algorithm is obtained with closed-form updates at each iteration. An example 700 of the algorithm is shown in FIG. 7, where ( ) is used as an index operator. These updates can be further rearranged, resulting in update equations numerically identical to the multiplicative update equations for non-negative matrix factorization with a KL divergence cost function, given proper initialization and normalization.

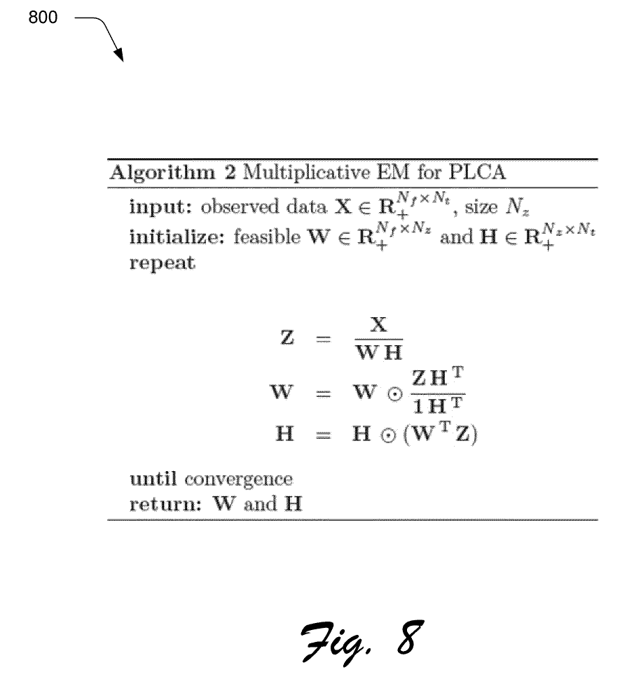

Algorithm 2 as shown in the example 800 of FIG. 8 illustrates the multiplicative update rules where “W” is a matrix of probability values such that “p(f|z)” is the “f^{th}” row and “z^{th}” column, “H” is a matrix of probability values such that “p(f|z)p(z)” is the “z^{th}” row and “t^{th}” column, “1” is an appropriately size matrix of ones, “⊙” is element-wise multiplication, and the division is element wise.

Given the latent variable model, the indications 208 may be incorporated as user-guided constraints to improve the separation quality of the techniques in an efficient and interactive manner. To accomplish this, a user may provide the indication 208 via user inputs after listening to the sound data that includes a mixture of sound data from different sources and iteratively refine the results as described above in relation to FIGS. 3-6. In this way, the algorithm may be continually retrained and thus correct for undesired results.

When painting on the input mixture spectrogram as in FIG. 4, for instance, a user may be directed to paint on the sound source for which he/she wishes to separate using different colors for different sources and brush opacity as a measure of intensity, e.g., strength.

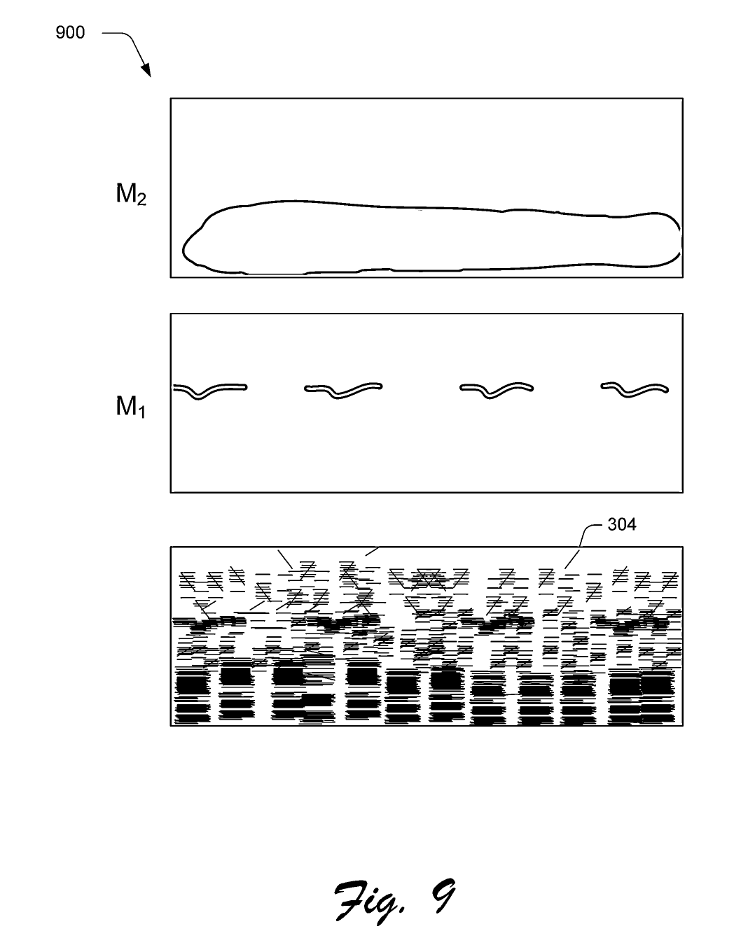

When painting on the intermediate output spectrograms as in FIG. 5, a user is asked to paint on the sound that does not belong in the given spectrogram, thereby interactively informing the algorithm “what it did right and wrong.” FIG. 9 illustrates an example implementation 900 showing the indications as image overlays for separating two sound sources as described in relation to FIG. 6.

To algorithmically achieve the proposed interaction, however, a technique may be employed to inject constraints into the model, e.g., as a function of time, frequency, and sound source. These techniques may also allow for interactive-rate (e.g., on the order of seconds) in processing the sound data 108 to perform the sound separation.

Posterior Regularization

Constraints may be incorporated into a latent variable model in a variety of ways. As mentioned above, the constraints may be grouped on each sound source as a function of both time and frequency, which results in applying constraints to the latent variable “z” of the above described model as a function of the observed variables “f” and “t.” To do so, the general framework of posterior regularization may be used, although other examples are also contemplated.

Posterior regularization for expectation maximization algorithms may be used as a way of injecting rich, typically data-dependent, constraints on posterior distributions of latent variable models. This may involve constraining the distribution “q(Z)” in some way when computing the expectation step of an EM algorithm.

For example, the general expectation step discussed above may be modified to incorporate posterior regularization, resulting in the following expression:

$${q}^{( t )} = {argmin}_{q} KL ( q \vert \vert p ) + Ω ( q )$$

where “Ω(q)” constrains the possible space of “q(Z).” Note, when “(q)=0,” “q(Z)” is optimal when equal to the posterior distribution as expected. This is in contrast to prior-based regularization, where the modified maximization step is as follows:

$${Θ}^{( t )} = {argmax}_{Θ} ℱ ( q , Θ ) + Ω ( Θ )$$

where “Ω(Θ)” constrains the model parameters “Θ”. Given the general framework above, the following for of regularization may be employed.

Linear Grouping Expectation Constraints

To support efficient incorporation of the indications 208 of user-annotated constraints into our latent variable model, a penalty “Ω(q)” may be defined. This may be performed by applying non-overlapping linear grouping constraints on the latent variable “z,” thereby encouraging distinct groupings of the model factors to explain distinct sources. The strength of the constraints may then be interactively tuned by a user as a function of the observed variables “f” and “t” in the model.

As a result, “q(Z)” may no longer be simply assigned to the posterior, and therefore a separate constrained optimization problem may be solved for each observed outcome value in the two-dimensional model. To do so, “q(Z)” may be rewritten using vector notation “q” and a modified expectation step may be solved for each value of “z” with an added linear group penalty on “q” as follows:

$$\begin{matrix}{argmin}_{q} & - {q}^{T} ln p + {q}^{T} ln q + {q}^{T} λ \\ subject to & {q}^{T} 1 = 1 , q ≽ 0.\end{matrix}$$

where “p” is the corresponding vector of posterior probabilities, “λεR^{N}^{_{Z}}” are user-defined penalty weights “^{T}” is a matrix transpose, “ [symbol] ” is element-wise greater than or equal to, and “1” is a column vector of ones. To impose groupings, the values of “z” are partitioned to correspond to different sources. Corresponding penalty coefficients are then chosen to be equivalent for each “z” within each group.

The grouping constraints may be illustrated as overlaid images similar to FIG. 9, but in which opacity represents a magnitude of a penalty for each group, i.e., the intensity. Each overlay image may be real-valued and represent all constraints “Λ^{s}εR^{N}^{×N}^{ₜ}” applied to each value of “z” for the corresponding source “s.” Taking a specific time-frequency point in each image, a linear penalty “λ” may be formed. In this example, “λ=[α,α,β,β,β]” for some “α, βεR.”

To solving the above optimization problem, a Lagrangian function is first formed as follows:

[symbol]

(q,α)=−q^{T} ln p+q^{T} ln q+q^{T}λ+α(1−q^{T}1)

with “α” being a Lagrange multiplier, the gradient is then calculated with respect to “q” and “α” as follows:

∇_{q} [symbol] (q,α)=−ln p+1+ln q+λ−α1

∇_{α} [symbol] =(1−q^{T}1)

These equations are then set equal to zero, and solve for “q”, resulting in the following:

$$q = \frac{p ⊙ exp \{ - λ \}}{{p}^{T} exp \{ - λ \}}$$

where “exp{ }” is an element-wise exponential function. Notice the result is computed in closed-form and does not involve any iterative optimization scheme as may be involved in the conventional posterior regularization framework, thereby limiting additional computational cost when incorporating the constraints as described above.

Posterior Regularized PLCA

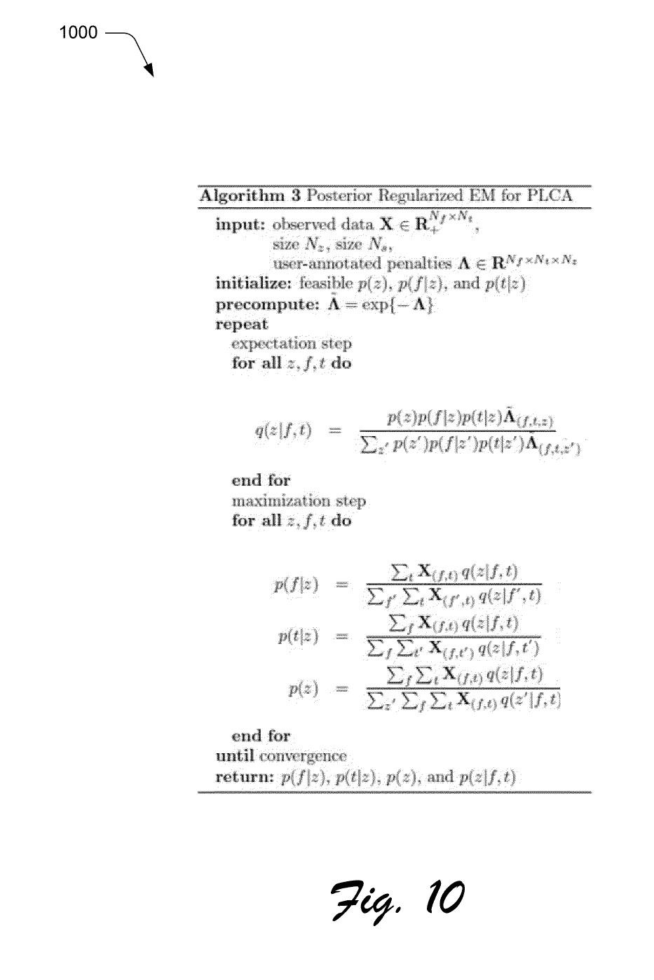

Knowing the posterior regularized expectation step optimization, a complete expectation maximization algorithm may be derived for a posterior regularized two-dimensional PLCA model. The may be performed through incorporation of the following expression:

$$q ( z \vert f , t ) = \frac{p ( z ) p ( f \vert z ) {\tilde{Λ}}_{( f , t , z )}}{{\sum }_{z} p ( z ) p ( f \vert z ) p ( t \vert z ) {\tilde{Λ}}_{( f , t , z )}}$$

where “ΛεR^{N}^{_{f}}^{×N}^{ₜ}^{×N}^{ₛ}” represents the entire set of real-valued grouping penalties, expanded and index by “z” for convenience and “\tilde{Λ}={−Λ}”. An example 1000 of an algorithm that incorporates this approach is shown in FIG. 10. It should be noted, closed-form expectation and maximization steps are maintained in this example, thereby supporting further optimization and to draw connections to multiplicative non-negative matrix factorization algorithms discussed below.

Multiplicative Update Equations

To compare the proposed method to the multiplicative form of the PLCA algorithm outlined in the example algorithm in FIG. 8, the expression in the example 1000 Algorithm of FIG. 10 may be rearranged and converted to multiplicative form. Rearranging the expectation and maximization steps, in conjunction with Bayes' rule, and

Z(f,t)=Σ_{Z}p(z)p(f|z)p(t|z)\tilde{Λ}_{(f,t,z)}

The following may be obtained:

$$q ( z \vert f , t ) = \frac{p ( f \vert z ) p ( t , z ) {\tilde{Λ}}_{( f , t , z )}}{Z ( f , t )}$$

$$p ( t , z ) = {\sum }_{f} {X}_{( f , t )} q ( z \vert f , t )$$

$$p ( f \vert z ) = \frac{{\sum }_{t} {X}_{( f , t )} q ( z \vert f , t )}{{\sum }_{t} p ( t , z )}$$

$$p ( z ) = {\sum }_{t} p ( t , z )$$

Rearranging further, the following expression is obtained:

$$p ( f \vert z ) = \frac{p ( f \vert z ) {\sum }_{t} \frac{{X}_{( f , t )} {\tilde{Λ}}_{( f , t , z )}}{Z ( f , t )} p ( t , z )}{{\sum }_{t} p ( t , z )}$$

$$p ( t , z ) = p ( t , z ) {\sum }_{f} p ( f \vert z ) \frac{{X}_{( f , t )} {\tilde{Λ}}_{( f , t , z )}}{Z ( f , t )}$$

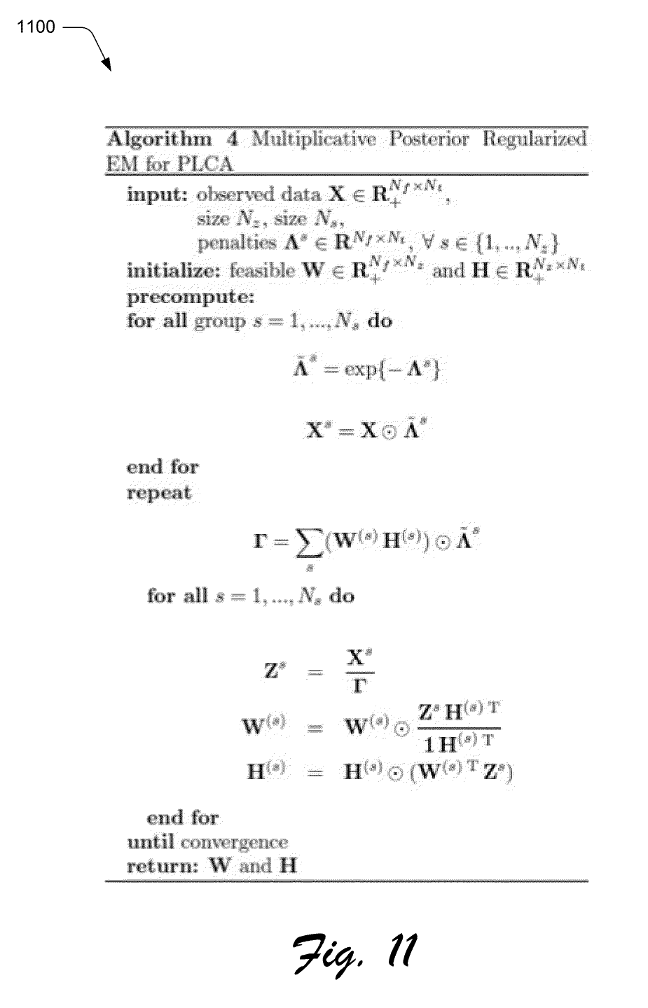

which fully specifies the iterative updates. By putting these expressions into matrix notation, the multiplicative form of the proposed techniques in the example algorithm 1100 of FIG. 11 are specified.

To do so, however, it is convenient to separate the tensor of penalties “A” into its respective groupings:

Λ^{s}εR^{N}^{_{f}}^{×N}^{ₜ}, ∀8 ε{1, . . . , N_{z}}

Additionally, the superscript “^{(s)}” may be denoted with parenthesis as an index operator that picks off the appropriate column or rows of a matrix for a given source, and the superscript “^{s}” without parenthesis as an enumeration of similar variables.

Sound Source Separation

To perform separation given a set of user-specified constraints as specified via interaction with the user interface 118, the example 1100 algorithm of FIG. 11 may be employed to reconstruct the distinct sound sources from the output. This may be performed by taking the output posterior distribution and computing the overall probability of each source “p(s|f,t)” by summing over the values of “z” that correspond to the source

Σ_{zεs}p(z|f,t)

or equivalently by computing “W^{(s)}H^{(s)}/WH.” The source probability is then used as a masking filter that is multiplied element-wise with the input mixture spectrogram “X,” and converted to an output time-domain audio signal using the original mixture STFT phase and an inverse STFT.

Example Procedures

The following discussion describes user interface techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-11.

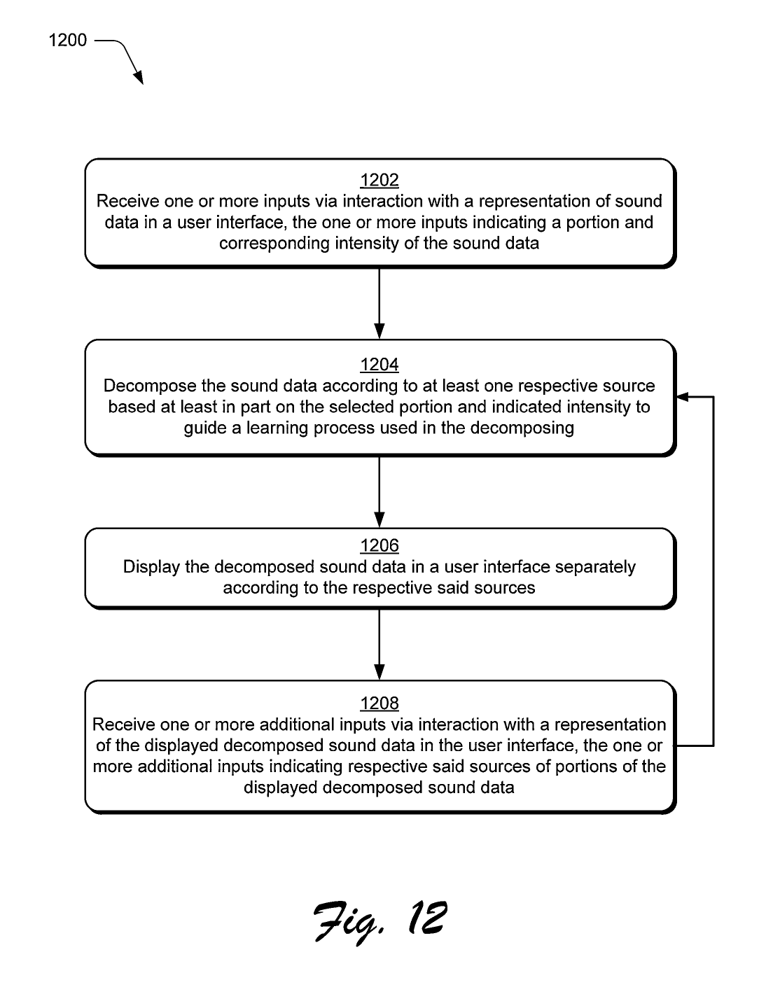

FIG. 12 depicts a procedure 1200 in an example implementation in which a user interface supports user interaction to guide decomposing of sound data. One or more inputs via interaction with a representation of sound data in a user interface, the one or more inputs indicating a portion and corresponding intensity of the sound data (block 1202). The one or more inputs, for instance, may be provided via a gesture, cursor control device, and so on to select a portion of the user interface 118. Intensity may also be indicated, such as through pressure associated with the one or more inputs, an amount different parts of the portion are “painted over” and thus an amount of interaction may be indicative of intensity, and so on.

The sound data is decomposed according to at least one respective source based at least in part on the selected portion and indicated intensity to guide a learning process used in the decomposing (block 1204). The decomposition module 116, for instance, may employ a component analysis module 212 to process the sound data 108 using the indication 208 as a weak label of portions of the sound data.

The decomposed sound data is displayed in a user interface separately according to the respective said sources (block 1206). As shown in the second stage 404 of FIG. 4, for instance, representations 408, 410 may be displayed concurrently as associated with a likely source. The representations 408, 410 may also be displayed concurrently with the representation 302 of the “mixed” sound data.

One or more additional inputs are received via interaction with a representation of the displayed decomposed sound data in the user interface, the one or more additional inputs indicating respective said sources of portions of the displayed decomposed sound data (block 1208). As shown in FIG. 5, for instance, these inputs may be used to further refine processing performed by the decomposition module 116. Thus, this process may be interactive as indicated by the arrow.

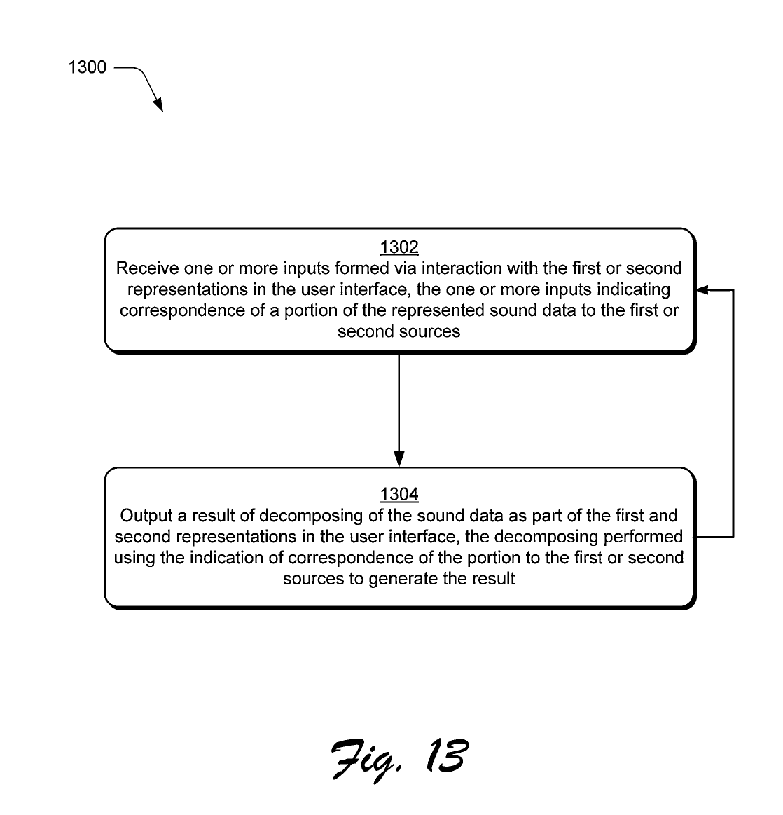

FIG. 13 depicts a procedure 1300 in an example implementation in which a user interface support simultaneous display of representations of audio data decomposed according to a plurality of different sources. One or more inputs are formed via interaction with the first or second representations in the user interface, the one or more inputs indicating correspondence of a portion of the represented sound data to the first or second sources (block 1302). The inputs, for instance, may indicate likely correspondence with individual sources, such as dialog of users and a ringing of a cell phone for the audio scene 110.

A result is output of decomposing of the sound data as part of the first and second representations in the user interface, the decomposing performed using the indication of correspondence of the portion to the first or second sources to generate the result (block 1304). As before, the inputs may be used to weakly label portions of the sound data which may then be used as a basis to perform the source separation. Through weak labels, the portions may be divided to a plurality of different sources as opposed to conventional techniques that employed strict labeling. This process may be interactive as indicated by the arrow. Other examples are also contemplated.

Example System and Device

FIG. 14 illustrates an example system generally at 1400 that includes an example computing device 1402 that is representative of one or more computing systems and/or devices that may implement the various techniques described herein. This is illustrated through inclusion of the sound processing module 112, which may be configured to process sound data, such as sound data captured by an sound capture device 104. The computing device 1402 may be, for example, a server of a service provider, a device associated with a client (e.g., a client device), an on-chip system, and/or any other suitable computing device or computing system.

The example computing device 1402 as illustrated includes a processing system 1404, one or more computer-readable media 1406, and one or more I/O interface 1408 that are communicatively coupled, one to another. Although not shown, the computing device 1402 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1404 is representative of functionality to perform one or more operations using hardware. Accordingly, the processing system 1404 is illustrated as including hardware element 1410 that may be configured as processors, functional blocks, and so forth. This may include implementation in hardware as an application specific integrated circuit or other logic device formed using one or more semiconductors. The hardware elements 1410 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1406 is illustrated as including memory/storage 1412. The memory/storage 1412 represents memory/storage capacity associated with one or more computer-readable media. The memory/storage component 1412 may include volatile media (such as random access memory (RAM)) and/or nonvolatile media (such as read only memory (ROM), Flash memory, optical disks, magnetic disks, and so forth). The memory/storage component 1412 may include fixed media (e.g., RAM, ROM, a fixed hard drive, and so on) as well as removable media (e.g., Flash memory, a removable hard drive, an optical disc, and so forth). The computer-readable media 1406 may be configured in a variety of other ways as further described below.

Input/output interface(s) 1408 are representative of functionality to allow a user to enter commands and information to computing device 1402, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1402 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1402. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1402, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1410 and computer-readable media 1406 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1410. The computing device 1402 may be configured to implement particular instructions and/or functions corresponding to the software and/or hardware modules. Accordingly, implementation of a module that is executable by the computing device 1402 as software may be achieved at least partially in hardware, e.g., through use of computer-readable storage media and/or hardware elements 1410 of the processing system 1404. The instructions and/or functions may be executable/operable by one or more articles of manufacture (for example, one or more computing devices 1402 and/or processing systems 1404) to implement techniques, modules, and examples described herein.

The techniques described herein may be supported by various configurations of the computing device 1402 and are not limited to the specific examples of the techniques described herein. This functionality may also be implemented all or in part through use of a distributed system, such as over a “cloud” 1414 via a platform 1416 as described below.

The cloud 1414 includes and/or is representative of a platform 1416 for resources 1418. The platform 1416 abstracts underlying functionality of hardware (e.g., servers) and software resources of the cloud 1414. The resources 1418 may include applications and/or data that can be utilized while computer processing is executed on servers that are remote from the computing device 1402. Resources 1418 can also include services provided over the Internet and/or through a subscriber network, such as a cellular or Wi-Fi network.

The platform 1416 may abstract resources and functions to connect the computing device 1402 with other computing devices. The platform 1416 may also serve to abstract scaling of resources to provide a corresponding level of scale to encountered demand for the resources 1418 that are implemented via the platform 1416. Accordingly, in an interconnected device embodiment, implementation of functionality described herein may be distributed throughout the system 1400. For example, the functionality may be implemented in part on the computing device 1402 as well as via the platform 1416 that abstracts the functionality of the cloud 1414.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by one or more computing devices, the method comprising:
receiving one or more inputs via interaction with a representation of sound data in a user interface, the one or more inputs indicating a portion and corresponding intensity of the sound data; and
decomposing the sound data according to at least one respective source based at least in part on the selected portion and indicated intensity.

2. A method as described in claim 1, wherein the indicating of the intensity includes indicating differences in the intensity at different parts of the selected portions.

3. A method as described in claim 1, wherein the selecting of the portion indicates a corresponding said source of sound data located at the portion.

4. A method as described in claim 1, wherein the one or more inputs indicates a plurality of said portions, each said portion corresponding to a respective said source.

5. A method as described in claim 1, wherein the decomposing is performed using a learning process that includes latent component analysis or posterior regularized latent component analysis.

6. A method as described in claim 1, wherein the receiving of the one or more inputs is performed using a brush tool.

7. A method as described in claim 1, wherein the decomposing is performed without using training data.

8. A method as described in claim 7, further comprising receiving one or more additional inputs via interaction with a representation of the displayed decomposed sound data in the user interface, the one or more additional inputs indicating respective said sources of portions of the displayed decomposed sound data.

9. A method as described in claim 1, wherein the decomposing is performed to support audio denoising, music transcription music remixing, or audio-based forensics.

10. One or more computer-readable storage media having instructions stored thereon that, responsive to execution on a computing device, causes the computing device to perform operations comprising:
outputting a user interface having first and second representations of respective parts of sound data decomposed from a recording based on a likelihood of corresponding to first and second sources, respectively;
receiving one or more inputs formed via interaction with the first or second representations in the user interface, the one or more inputs indicating correspondence of a portion of the represented sound data to the first or second sources; and
outputting a result of decomposing of the sound data as part of the first and second representations in the user interface, the decomposing performed using the indication of correspondence of the portion to the first or second sources to generate the result.

11. One or more computer-readable storage media as described in claim 10, wherein the one or more inputs indicate that the portion is included in the first representation correctly corresponds to the first source.

12. One or more computer-readable storage media as described in claim 10, wherein the one or more inputs indicate that the portion is included in the first representation corresponds to the second source.

13. One or more computer-readable storage media as described in claim 10, wherein the decomposing is performed by using the indication of correspondence of the portion to the first or second sources to guide a learning process to perform the decomposing based on a likelihood of correspondence of the sound data to the first and second sources.

14. One or more computer-readable storage media as described in claim 10, wherein the outputting of the first and second representations in the user interface is performed such that the first and second representations are displayed concurrently.

15. One or more computer-readable storage media as described in claim 10, wherein the one or more inputs also indicate an intensity that is usable to guide the composing.

16. A system comprising:
at least one module implemented at least partially in hardware and configured to output a user interface having a plurality of representations, each said representation corresponding to sound data decomposed from a recording based on likelihood of corresponding to a respective one of a plurality of sources source; and
one or more modules implemented at least partially in hardware and configured to constrain a latent variable model usable to iteratively decompose the sound data from the recording based on one or more inputs received via interaction that are iteratively perform with respect to the user interface to identify one or more portions of the sound data as corresponding to a respective said source.

17. A system as described in claim 16, wherein the plurality of representations includes time/frequency representations.

18. A system as described in claim 16, wherein the one or more inputs are further configured to specify an intensity that is usable in conjunction with the latent variable model to decompose the sound data from the recording.

19. A system as described in claim 16, wherein the latent variable model employs probabilistic latent component analysis.

20. A system as described in claim 16, wherein the plurality of representations are displayed concurrently in the user interface along with a representation of the sound data from the recording that is not decomposed.
